(19) United States
(12) Patent Application Publication
(10) Pub. No.: US 2024/0292106 A1
(43) Pub. Date: Aug. 29, 2024

(54) 360 VR-PPP

(71) Applicant: Kevin VERNON, Hamilton (CA)

(72) Inventor: Kevin VERNON, Hamilton (CA)

(21) Appl. No.: 18/445,645

(22) Filed: Dec. 11, 2023

(51) Int. Cl. H04N 23/698; G02B 27/00; G02B 27/01

(52) U.S. Cl. CPC H04N 23/698; G02B 27/0093; G02B 27/017; G02B 2027/0138

(57) ABSTRACT

The 360VR-PPP software APP is a computing program that solves the equation of enabling a single lens camera to operate as a 360 degree perpetual panning panoramic virtual reality camera. This premise was first introduced in CIPO Patent application filing dates of Feb. 10, 2021; Socket Camera #3108490 and Socket Camera APP #3171316. USPTO Socket Camera #17/304,668 and USPTO Socket Camera application Ser. No. 17/803,662. This Patent Application will give in detail how this software will command a single lens camera to pan in perpetuity 360 degrees with a shutter speed of 1/7920 s and higher to capture images that will play back as 22 FPS or more in video. To be viewed in a VR headset in a true panoramic virtual reality.

### FIELD OF INVENTION

The present invention details a computing software application that will facilitate a single lens camera to rotate 360 degrees panoramic perpetually panning with a shutter speed capable of 1/7920 s and higher to render video of 22 FPS or more. This application solves the premise that was first introduced in CIPO Patent application; Socket Camera #3108490, Socket Camera APP #3171316. USPTO Patent applications, USPTO Socket Camera #17/304,668 and USPTO Socket Camera application Ser. No. 17/803,662.

### BACKGROUND OF THE INVENTION

As technology advances su does the need for innovation. Advancements in camera technology has always been a leading trend. From better resolution, to where and how cameras and video can be used. The 360 VR-PPP is the embodiment of software that promotes the advancement of camera and video technology. This software encompasses an improvement and ease of technology. A user will no longer need a plurality of cameras to achieve a true virtual reality render, This is more cost effective. To have 1 high quality lens as opposed to 10 or more high quality lenses. This software utilizes some video stitching components but brings that technology to a higher and better usefulness. It is a technological improvement.

### BRIEF SUMMARY OF THE INVENTION

This software will facilitate that a single lens 360 degree panoramic perpetual panning camera with a shutter speed of 1/7920 s or greater shall capture 22 FPS or more for every 1 degree increment of 360 degrees. With the camera achieving a full 360 degree rotation in 1 second or less. With a rotation speed as such and a shutter speed as such. A camera shall be able to capture 22 FPS on every 1 degree increment of a 360 degree rotation. The captured video shall be stitched and blended sequentially with other or all of the video captured by the lens. To aid with transitions of the different video feeds along side stitching, video scrubbing as used in video editing shall be implemented. As well as elements utilized by a television studio switcher unit.

### BRIEF DESCRIPTION OF THE DRAWINGS

Some embodiment of the presented invention are illustrated as an example and are not limited by the figures of the accompanying drawings.

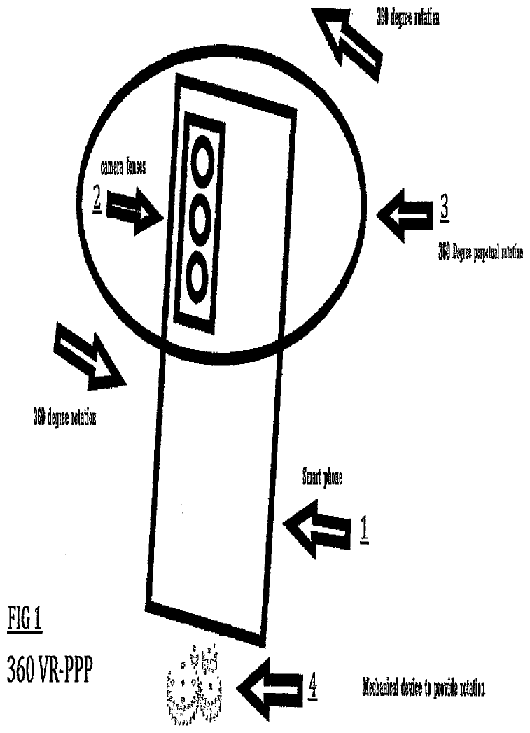

FIG. 1. Is a representation of the source device in which the 360 VR-PPP software has been installed. In this diagram it is a smartphone. This diagram indicates that the source device must be in perpetual rotation.
1. is the source device in which the software had been downloaded to.
2. is a series of camera lenses.
3. is a circle which is a representation of the perpetual 360 degree rotation.
4. are gears as an indication that a smartphone would require an external device that could provide the required rotation.

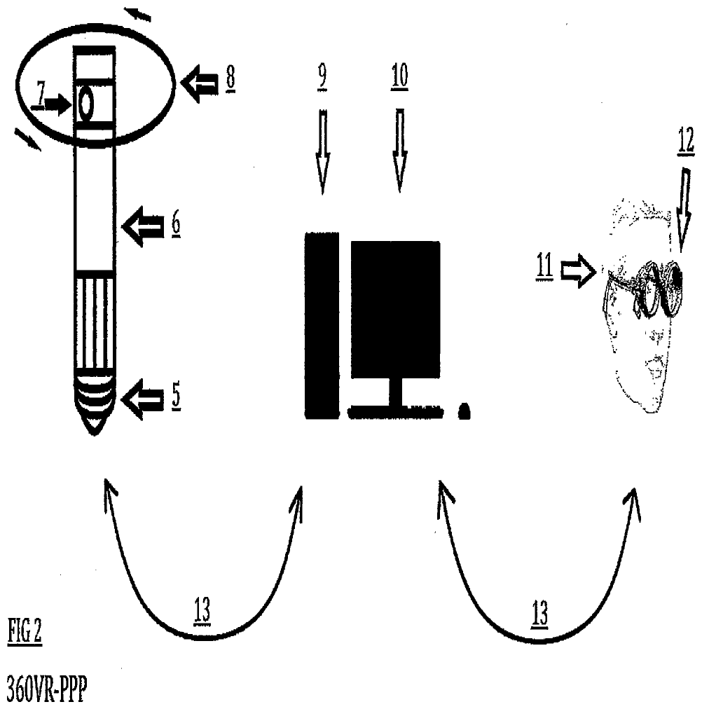

FIG. 2, is a representation of the software installed to a desktop computer working with the peripherals. Which are a light bulb camera and a VR headset.
5. is an Edison screw threading to install into a electrified socket.
6. is a Socket Camera or light bulb camera
7. is a high quality lens.
8, is a circle which is a representation of the perpetual 360 degree rotation.
9. is the computer. CPU and hard drives with the 360 VR-PPP software
10. is the computer monitor.
11. is the user.
12. is the VR headset worn by the user.
13. is the direction of data flow.

### DETAILED DESCRIPTION OF THE INVENTION

To aid in the concepts of what shall make this software functional, some background is to be given on the terminology. According to Wikipedia, a forum where definitions are submitted and widely accepted by the general public; Image stitching or photo stitching is the process of combining multiple photographic images and video with overlapping fields of view to produce a segmented panorama or high resolution image. Commonly performed through the use of computer software, most approaches to image stitching require nearly exact overlaps between images and identical exposures to produce seamless results. The image stitching process can be divided into three main components: image registration, calibration, and blending. Social media platform TIK TOK boasts that the user is able to stitch their media with that of other users to create very smooth video transitions in making their own videos.

As the videos that are captured by this software are intended to be view whilst donning a VR headset. One must take into consideration that when the user is turning their head left or right, the view finder in the VR headset must show the appropriate images to the wearer as they turn their head. This is when video scrubbing shall be implemented. Video scrubbing is a technique used in video editing to manually move across a number of sequential video frames. In the editing process the user muves a cursor across the footage frame by frame. This software will implement this movement without a cursor. As the user turns their head left or right this software will scrub across video frames smoothly until the head movement of the user stops at which point the captured video will begin to play again, This process will later be expounded in the description. This passage is intended only to familiarize the reader with video stitching and video scrubbing.

Another process in which background must be given is that of a television studio video switcher. When one is watching a Hockey, Basketball or football game. They are watching a high quality LIVE studio production and process. 40 or more cameras with live video feeds may be in operation simultaneously. The switcher console is the unit that receives all of the video feeds and organizes the feeds. The director, observing all 40 cameras will issue commands to the switcher operator to transition from camera to camera using cut/takes, wipes, dissolves, super imposition etc to give the viewer at homo an enhanced viewing experience of a LIVE sporting event. The 360 VR-PPP software will utilize the principles of a television control room switcher unit enabling the switching of recorded video feeds for an enhanced user experience. This software shall be equipped with all the capabilities and effects of a television switcher unit at its disposal. Since this inventive software has the capability of rendering usable video at every 1 degree increment of the 360 degree perpetual rotation it is possible for this software to have 360 video feeds of viable footage.

Currently shutter speeds are as fast as 1/8000 s and will be getting ever faster with the advancement of technology. This software shall be implemented on a device such as the Socket Camera or a smart phone such as an I phone which has a shutter speed capable of 1/8000 s. Provided that the smartphone could be secured to a tripod device that will give it perpetual rotation. The formula for the 360 VR-PPP is as such. With the shutter speed commanded to act at 1/7920 s and rotate 360 degrees perpetually every 1 second. This will allow the CPU to collect 22FPS at every 1 degree increment of 360 degrees. If the software commands a higher rotation speed ie; a full 360 degree rotation in 0.50 seconds the CPU will still collect 22FPS but after 2 complete rotations. The higher rotation speed will mitigate any loss of capture of quicker movements in the vicinity of the camera. With the shutter speed at 1/7920 s, the command can still be issued for an even faster 360 degree rotation. The human eye needs only 15 FPS to recognize a subject as being in motion. So 22 FPS is an adequate capture speed to render usable video. As this software can capture 22 Frames at every 1 degree increment of 360 degrees this software can start to create 360 individual video feeds because every 1 degree increment will fulfill its frame capture rate after a rotation cycle in 1 second of a 360 degree rotation.

As an example, this software is reminiscent of a toy that one may have had as a child. The toy was in the shape of a megaphone. It had a view finder, a crank and you would insert a cartridge with still frames. The faster that you turned the crank you will eventually get a subject in motion from all the frames going by. This is why this software shall put the lens in perpetual motion. At any one degree increment of the 360 degrees; when the lens is rotating in a complete circle in 1 second or less, the software shall capture the subject at 22 FPS repeatedly and perpetually at that 1 degree increment until the subject leaves the field of view. Fast enough motion, with increments of movement appear as a moving subject to the human eye. Itis like having a thick novel and in the top corner of the page is a stick man. If a tiny transition of movement is given to the stick figure and you turn the pages quickly with your thumb it will put the stick figure in motion. Or like in stop motion animation. The artist would take a still photo of the clay subject The artist would go move the subject slightly and repeat this action until the subject completes a full movement. Then simply plays the compiled frames quickly and the clay figure comes to life. This is another aspect and reason why the perpetual rotation at a high speed is necessary, Combined with the subject being captured at 22 FPS on every rotation produces fluid movement. It would be superfluous to render 360 videos as this would be taxing on the CPU and memory but this option is not ruled out. For the sake of preserving memory and giving an easier task to the CPU. This software will use the same format of organizing captured video as a still image panoramic 360 degree Capture would use, It is to be appreciated that this software will not be operating in real time. The watchable video will not be available until all video has been rendered. When creating a panoramic photo of still images, usually 36 images are necessary with the images captured being 10 degrees apart. So as an example for this software every 10 degrees of the 360 degrees that have been captured this software will start to produce a video feed but the user could select 18, 9 or 4 video feeds. The amount of video feeds shall remain optional to the user. 36 video feeds will be used as an example at every 10 degrees. As there will be a mark/position or video feed every 10 degrees of 360 degrees this will allow for 36 video feeds to be created by the software. 36 videos are now available after processing and saving. These 36 video feeds shall be available to the user to stitch and edit in post production and create VR movies for their pleasure or for business purposes that can be viewed in a VR headset, TV, monitor or smart device.

This software shall implement capabilities so that when the user is donning a VR headset they shall be able to watch the captured footage in VR in the headset. The sensors in the VR head set that create the virtual reality effect can detect when the user turns their head left or right and shall display the corresponding movement in the viewfinder of the VR headset, On a smart device, the user shall be able to swipe their finger to activate panning. When touch screen is not available. The user can use a keyboard or mouse to activate panning. As the user can only turn their head left or right; in this purpose. As this edition of the patent application software facilitates perpetual panning of a single lens camera. In the future this software may be upgraded to facilitate a plurality of cameras in a camera array in which case the availability of viable video feeds would increase exponentially, In continuation of the single lens application. When the user turns their head left or right the software need only to stitch adjacent videos to each other sequentially as the lens is only panning left or right. As it is the same lens, all the videos are already synced in all facets. To aid in the transitions of adjacent video in case of a rapid head turn. The software has the ability to trigger a video editing scrub. Whereas the software would only need to display adjacent frames in the direction of the head turning and the quick motion of the head turn will be the motion that is needed to let the human eye perceive movement. Like the earlier analogy of the novel with the stick man in the upper corner. For the purpose of example we were explaining a 36 video feed similar to the 36 shot panoramic photographic render. With the video feeds in this case being 10 degrees apart. When the user is wearing the VR headset and turns their head to the right the sensors in the VR headset will recognized that the user is turning their head to the right When this occurs the software has to introduce a transition like that of a television studio switcher. The most common transition that this software shall utilize would be that of a video wipe but the transition could be a hybrid of transitions. A wipe with super imposition and fade. A wipe is a video transition whereas the hew video that is being introduced pushes the existing video on screen to the other side of the screen until it is gone. Leaving only the new video. So both videos shall share the screen for a duration. This wipe would have no border so you will not be able to see where one video feed ends and the next one begins. With a video imposition, the software shall make adjustments for the 10 degree difference. There are also usable frames in between the 10 degree difference the software can utilize. The video is almost doing a transition of a wipe into to same picture composition as it is only 10 degrees offset. The software shall make a 10 degree adjustment stitch in transition simultaneously with a wipe transition. As an example, If there were a tree on the right side of the video feed and the user turns their head to the right. As these videos would already be in sync because they were captured by the same lens. The software could detect the colour variances of the picture composition or recognize texts and patterns similar to facial recognition and text recognition. It would align the tree with the incoming video feed of the tree that would move to the left side of the video feed. This could be done within a few frames until the wipe transition has been completed.

### DETAILED DESCRIPTION OF THE DRAWINGS

FIG. 1. Is a representation of a smartphone that has the 360 VR-PPP installed. This software would enable such a device to capture 360 degree virtual reality videos provided that this smartphone is mounted to a mechanism that is able to rotate it 360 degrees perpetually, completing a rotation cycle in 1 second or less. This software will set the shutter speed to 1/7920 or greater allowing the smartphone to capture 22 f every 1 degree increment of the 360 degrees.

1. As indicated in FIG. 1 is the source device. The source device would be any such device as stated in the diagram description of FIG. 1.

The source device is the CPU and computing interface that the 360 VR-PPP has been installed or downloaded to. On this device the user will be able to view captured footage and perform all of the functions and features of the 360 VR-PPP. This App will provide features such as a video editor, video capturing, video switcher capabilities. This source device will provide the interface for the VR headset and controller system to interact with the software.

2. As indicated in FIG. 1 are the camera lenses. This software shall command the rolling shutter to capture images at a shutter speed of 1/7920 s or greater. With the shutter speed set at 1/7920 s the camera shall capture footage at 22 FPS for processing.

3. As indicated in FIG. 1 is depicted a circle that is the indication that the smartphone must be rotated perpetually 360 degrees. It shall be a Perpetually, Panning, Panoramic capture.

4. As indicated in FIG. 1 gives explicit indication that a smartphone must employ an exterior mechanism that will provide the perpetual rotation.

FIG. 2. Is a representation of a desk top computer implementing the 360 VR-PPP software system in use with the peripherals of a camera and the VR headset. The Light bulb camera in this diagram requires a source device in which the software has been installed. In this case a desktop computer. The Light bulb camera is implementing its Perpetually, Panning, Panoramic capture and sending the data to the CPU for processing. When the transference of data has been completed. The software will make available functions like the video editor, video switching capabilities and various effects. After the camera has sent all the data to the CPU, 360 video feeds will be available. 1 video feed for every 1 degree Increment of the perpetual 360 degree panoramic panning.

5. As indicated in FIG. 2 is the Edison screw threading. Applicable only for the Socket Camera or light bulb camera to attain electrification.

6. As indicated in FIG. 2 is the Socket Camera, light bulb camera or any remote camera capable of perpetual 360 degree rotation and is controlled by a source device.

7. As indicated in FIG. 2 is a high quality camera lens. This software shall command the rolling shutter to capture images at a shutter speed of 1/7920 s or greater.

With the shutter speed set at 1/7920 s the camera shall capture footage at 22 FPS after every 360 degree rotation completed in 1 second or less for processing.

8. As indicated in FIG. 2 is depicted a circle that is the indication that this device must be rotated perpetually 360 degrees. It shall be a Perpetually, Panning, Panoramic capture.

9. As indicated in FIG. 2 is depicted the computer tower containing the CPU and memory. This is where all the calculations regarding the software will be computed. Video editing will be enabled. Video switching, stitching and scrubbing will be enabled. The interface with the VR headset will be configured here.

10. As indicated in FIG. 2 is the computer monitor. If the user elects not to use the VR headset they can interface with the monitor and interact and give tasks to the software to perform.

11. As indicated in FIG. 2 is the user. The individual interacting with the software.

12. As Indicated in FIG. 2 is the VR headset interface. The user shall don the VR headset. The headset shall enable the viewing of all the captured footage in virtual reality. The sensors in the VR headset that create the virtual reality effect can distinguish when the user is turning their head left or right. As such, the software will send the corresponding video to the VR headset of panning left or right. This will immerse the wearer of the VR headset in a virtual reality experience. This software shall implement aspects of video stitching, video switching and video scrubbing to achieve this.

13. As indicated in FIG. 2 is the flow and process of data delivery and sequence.

### DESCRIPTION OF THE PREFERRED EMBODIMENTS

Let it be recognized some possible set ups and uses of this invention idea This software can be utilized on a smartphone by any member of the general public professional or novice alike, to create high quality panoramic virtual reality video, A big advancement in technology from simply taking a panoramic photo. Using a distortion free lens, captures will be more realistic enhancing the viewer experience. Editing software. Audio and Video will be available as a upgraded second tier offering and the user will be able to shoot and edit high quality true virtual reality movies that can be watched in a virtual reality headset. As this software is reactive to the head movement of a user donning a VR headset. The user will truly be immersed in a 360 degree video production, Past technology would be that a patron would go to a movie theatre, put on 3D glasses and watch a movie in 3D. This software makes it viable that a patron could go to a movie theatre and don a VR headset and watch a big budget production in true panoramic virtual reality.

This software easily has at the ready applications for security and surveillance systems also. As one lens has the ability to provide 360 video feeds, encompassing a 360 degree Field of view. A camera utilizing this technology could be fixed in stadiums and arenas, Big box stores or even for just home security.

1. I claim that the 360VR-PPP is a software application that shall send data and give commands to a computer or smart device that will be known as the source device. This source device shall be any device with one or more camera lenses. This source device shall have a CPU and sufficient memory to operate this software. If this device does not have a CPU and sufficient memory it shall be a peripheral of a device that does. This software shall command the lens to operate and capture images with a shutter speed of 1/7920 s or faster. This software shall command the camera device to rotate 360 degrees perpetually in 1 second or less. If the source device is unable to rotate perpetually under its own power it shall be connected to a mechanism that shall enable it to do so. This software shall enable any single camera lens to capture 22 frames per second or more after each 360 degree rotation. This software shall create 1 viable video feed for every 1 degree increment of a 360 degree rotation.

2. The 360VR-PPP software shall send data and give commands to a VR headset This software shall enable a VR headset to perform the functions of a television studio video switcher. This software shall be reactive to the head movements of a user donning a VR headset This software shall utilize the spatial and movement awareness provided by the sensors in a VR headset so that when the user burns their head left or right this software will implement video transitions from adjacent video feeds. This software shall implement video scrubbing to aid in faster transitions. This software shall implement video stitching to aid in transitions in the VR headset
